(19) United States
(12) Patent Application Publication
(10) Pub. No.: US 2025/0211426 A1
(43) Pub. Date: Jun. 26, 2025

(54) ELECTRONIC CONTROL UNIT, KEY VERIFICATION METHOD, STORAGE MEDIUM STORING KEY VERIFICATION PROGRAM, AND KEY MANAGEMENT SYSTEM

(71) Applicant: DENSO CORPORATION, Kariya-city (JP)

(72) Inventors: Eiichi OKUNO, Kariya-city (JP); Yasuhiro MIZUMACHI, Kariya-city (JP)

(21) Appl. No.: 19/081,674

(22) Filed: Mar. 17, 2025

Related U.S. Application Data
(63) Continuation of application No. PCT/JP2023/029755, filed on Aug. 17, 2023.

(30) Foreign Application Priority Data
Sep. 20, 2022 (JP) 2022-149536

(51) Int. Cl. H04L 9/08; H04L 9/32

(52) U.S. Cl. CPC H04L 9/0825; H04L 9/0894; H04L 9/3263; H04L 9/3297; H04L 2209/84

(57) ABSTRACT

An electronic control unit, a key verification method, a non-transitory computer-readable storage medium storing a key verification program, an electronic control system or a key management system stores a key, and verifies, for each predetermined time, the key with key information that is information related to the key and is stored in a distributed ledger placed outside a vehicle.

### CROSS REFERENCE TO RELATED APPLICATIONS

The present application is a continuation application of International Patent Application No. PCT/JP2023/029755 filed on Aug. 17, 2023, which designated the U.S. and claims the benefit of priority from Japanese Patent Application No. 2022-149536 filed on Sep. 20, 2022. The entire disclosures of all of the above applications are incorporated herein by reference.

### TECHNICAL FIELD

The present application relates to an electronic control unit, a key verification method, a key verification program, and a key management system for verifying keys used for encryption, decryption, and the like.

### BACKGROUND

In recent years, technologies that utilize V2X (vehicle-to-everything) such as vehicle-to-vehicle communication and vehicle-to-infrastructure communication to provide vehicle driving assistance and automated driving control have been attracting attention. As a result, vehicles are equipped with communication functions, increasing the likelihood that the vehicles will be subject to cyber attacks such as hacking. Further, vehicles need stronger defenses against the cyber attacks because the vehicles could lose control.

A vehicle is equipped with multiple electronic control units that are mutually connected via a network. Driving a vehicle, particularly driving assistance and automated driving control, requires transmission and reception of information through communication between these multiple electronic control units. As a comparative example, a countermeasure against the cyber attacks on communications between multiple electronic control units, for example, encrypts communication target data in communications between multiple control devices, and manages the encryption key used for this encryption within the vehicle.

### SUMMARY

An electronic control unit, a key verification method, a non-transitory computer-readable storage medium storing a key verification program, or a key management system stores a key, and verifies, for each predetermined time, the key with key information that is information related to the key and is stored in a distributed ledger placed outside a vehicle.

### BRIEF DESCRIPTION OF THE DRAWINGS

The above and other features and advantages of the present disclosure will become more apparent from the following detailed description made with reference to the accompanying drawings, in which like parts are designated by like reference numerals.

FIG. 1 is a diagram showing an example of the configuration of a key management system according to each embodiment of the present disclosure.

FIG. 2 is a block diagram showing a configuration example of an electronic control system according to each embodiment of the present disclosure.

FIG. 3A is a block diagram showing an overview of features of each embodiment of the present disclosure.

FIG. 3B1 is a block diagram showing an overview of features of each embodiment of the present disclosure.

FIG. 3B2 is a block diagram showing an overview of features of each embodiment of the present disclosure.

FIG. 4C1 is a block diagram showing an overview of features of each embodiment of the present disclosure.

FIG. 4C2 is a block diagram showing an overview of features of each embodiment of the present disclosure.

FIG. 5 is a block diagram showing a configuration example of an electronic control system and an electronic control unit according to a first embodiment of the present disclosure.

FIG. 6 is a flowchart showing operations of the electronic control unit according to the first embodiment of the present disclosure.

FIG. 7 is a flowchart showing operations of the electronic control unit according to the first embodiment of the present disclosure.

FIG. 8 is a block diagram showing a configuration example of the electronic control system and the electronic control unit according to a second embodiment of the present disclosure.

FIG. 9 is a block diagram showing a configuration example of the electronic control system and the electronic control unit according to a modification of the second embodiment of the present disclosure.

FIG. 10 is a block diagram showing a configuration example of the electronic control system and the electronic control unit according to a third embodiment of the present disclosure.

FIG. 11 is a block diagram showing a configuration example of the electronic control system and the electronic control unit according to a modification of the third embodiment of the present disclosure.

FIG. 12 is a flowchart showing operations of the electronic control unit according to the third embodiment of the present disclosure.

FIG. 13 is a flowchart showing operations of the electronic control unit according to the modification of the third embodiment of the present disclosure.

FIG. 14A is a block diagram showing an overview of an electronic control system according to a fourth embodiment of the present disclosure.

FIG. 14B is a block diagram showing an overview of an electronic control system according to a fourth embodiment of the present disclosure.

FIG. 14C is a block diagram showing an overview of an electronic control system according to a fourth embodiment of the present disclosure.

FIG. 15 is a block diagram showing a configuration example of the electronic control system and the electronic control unit according to a fourth embodiment of the present disclosure.

### DETAILED DESCRIPTION

Here, the inventors of the present disclosure have found the following difficulty as a result of detailed study. The driving assistance and automated driving control described above require highly reliable vehicle control. Therefore, more robust countermeasures against cyber attacks on communications between multiple electronic control units are required. Of course, the same applies to normal operation. However, when the encryption key used in communication between multiple electronic control units is managed only within the vehicle, the encryption key could be falsified by a cyber attack on the vehicle. There is a difficulty in the security of the network within the vehicle.

One example of the present disclosure provides an electronic control unit, a key verification method, a key verification program, and a key management system capable of improving the reliability of encryption keys used in communications between electronic control units of mobile bodies.

According to one example embodiment of the present disclosure, an electronic control unit mounted on a vehicle includes: a storage that stores a key; and a verification unit configured to verify, for each predetermined time, the key stored in the storage with key information that is information related to the key and is stored in a distributed ledger placed outside the vehicle.

According to another example embodiment of the present disclosure, an electronic control system includes: multiple electronic control units mounted on a vehicle. Each electronic control unit includes: a storage that stores a key; and a verification unit configured to verify, for each predetermined time, the key stored in the storage with key information that is information related to the key and is stored in a distributed ledger.

According to another example embodiment, a key management system includes: an electronic control unit mounted on a vehicle; and a distributed ledger placed outside the vehicle. The electronic control unit includes: a storage that stores a key; and a verification unit configured to verify, for each predetermined time, the key stored in the storage with key information that is information related to the key and is stored in a distributed ledger.

According to another example embodiment, a key management system includes: an electronic control unit mounted on a vehicle; a distributed ledger placed outside the vehicle; and a certificate authority. The electronic control unit includes: a storage that stores a key; a verification unit configured to verify, for each predetermined time, the key stored in the storage with key information that is information related to the key and is stored in a distributed ledger; and a validity confirmation unit configured to confirm a validity of the digital certificate related to the key via a certificate authority.

According to another example embodiment, a key management system includes an electronic control system including a first electronic control unit and a second electronic control unit mounted on a vehicle. The first electronic control unit includes: a first storage that stores a key; and a first verification unit configured to verify, for each first predetermined time, the key stored in the first storage with first key information that is information related to the key and is stored in the second electronic control unit. The second electronic control unit includes: a second storage that stores the key; and a second verification unit configured to verify, for each second predetermined time, the key stored in the second storage with second key information that is information related to the key and is stored in a distributed ledger placed outside the vehicle.

According to the above-described configuration, it is possible to improve the reliability of the encryption key used in the communication between electronic control units of the mobile body.

The following will describe embodiments of the present disclosure with reference to the drawings.

When there are multiple embodiments, a configuration disclosed in each embodiment may not be limited to each embodiment, alternatively, configurations can be combined across embodiments. For example, the configuration disclosed in one embodiment may be combined with other embodiments. The disclosed configurations in respective multiple embodiments may be partially combined.

### 1. Prerequisites for Each Embodiment

### (1) Overall Configuration of Key Management System

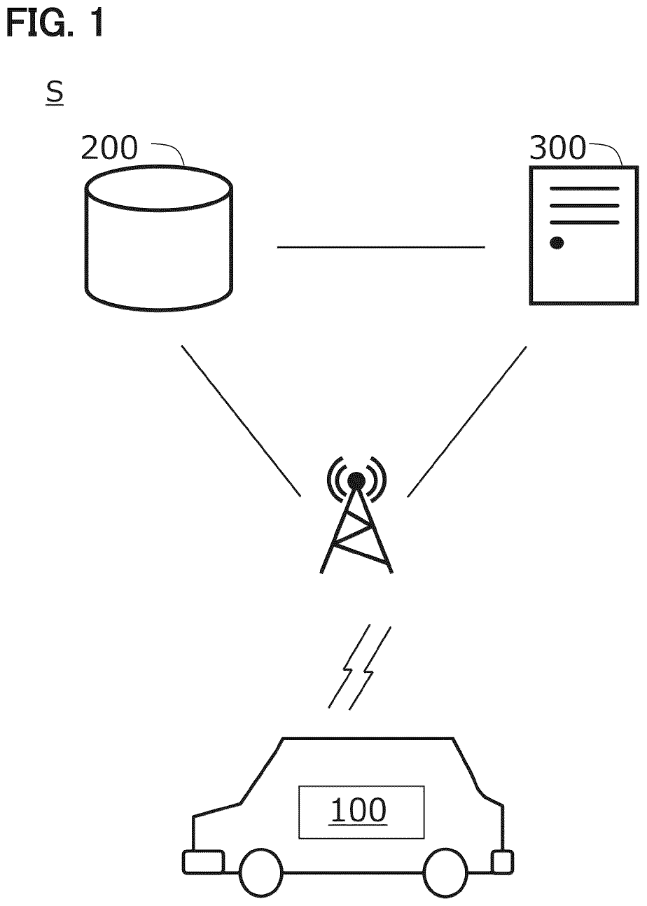

An overall configuration of a key management system S will be described with reference to FIG. 1.

The key management system S includes an electronic control system 100 mounted on a vehicle that is a mobile object, a distributed ledger 200, and a certificate authority 300. Herein, the “vehicle” refers to a movable object, and the speed of movement is arbitrary. The movable state also includes a vehicle stop state. Examples of the vehicle include, but are not limited to, an automobile, a motorcycle, a bicycle, and an object mounted thereon. The “mounted” state includes not only a state where an object is directly fixed to the mobile object but also a state where an object is moved together with the mobile object although the object is not fixed to the mobile object. Examples of the object include an object carried by a user who is in the mobile object and an object attached to a load carried by the mobile object.

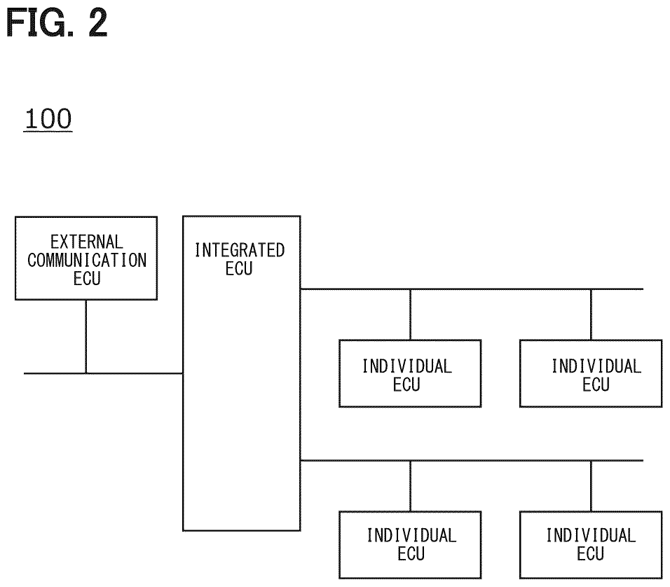

The electronic control system 100 includes multiple electronic control units (ECUs) and an in-vehicle network that connects the ECUs together. The electronic control system 100 will be described in detail later with reference to FIG. 2.

The distributed ledger 200, also referred to as a shared ledger or distributed ledger technology (DLT), is digital data that is agreed to be replicated, shared, and synchronized across multiple geographic locations, countries, institutions, or the like. More specifically, part of the database (ledger information) is shared among multiple users, and the same ledger information is held within each user system.

The distributed ledger 200 stores key information, which is information regarding the keys used in the electronic control system 100, in the key management system S of each embodiment. In each embodiment, the distributed ledger 200 is placed outside the vehicle. In each embodiment, the key is expressed as key Xn (n is an integer) and the key information is expressed as key information Xn (n is an integer). However, key information having the same Xn as a key means key information generated from the key Xn. In addition, for X, K indicates a common key, S indicates a secret key, and P indicates a public key. However, these are merely examples, and other types of keys may be used.

In FIG. 1, the distributed ledger 200 is illustrated in a single storage device, but in reality, it is stored in a distributed manner across multiple storage devices. Each storage is implemented, for example, on a server outside the vehicle or on a cloud server. However, the distributed ledger 200 may be provided in the vehicle so as to be connected to the electronic control system 100, or may be provided inside the electronic control system 100.

The certificate authority 300 issues a digital certificate that electronically certifies the authenticity of the key. For example, the certificate authority 300 confirms the identity of the key owner in some way and issues a digital certificate that guarantees the key and its owner. In particular, in the key management system S of the third and fourth embodiments, the certificate authority 300 confirms the validity of the digital certificate in response to a request from an ECU constituting the electronic control system 100.

The certificate authority 300 is implemented, for example, by a server outside the vehicle or a cloud server. Examples of external servers and cloud servers include servers installed by manufacturers and distributors of the vehicle and electronic control system 100.

In addition, in FIG. 1, the distributed ledger 200 and the certificate authority 300 are implemented as separate devices, but the distributed ledger 200 and the certificate authority 300 may be implemented on the same server or cloud server.

The electronic control system 100 and the distributed ledger 200, and the electronic control system 100 and the certificate authority 300 are connected via a communication network using a wireless communication method and/or a wired communication method. Examples of the wireless communication method include, for example, IEEE802.11 (Wi-Fi: registered trademark), IEEE802.16 (WiMAX: registered trademark), W-CDMA (Wideband Code Division Multiple Access), HSPA (High Speed Packet Access), LTE (Long Term Evolution), LTE-A (Long Term Evolution Advanced), 4G, 5G, and the like. Alternatively, dedicated short range communication (DSRC) can be used. Examples of wired communication methods that can be used include a LAN (Local Area Network) such as Ethernet (registered trademark), the Internet, optical fiber lines, and fixed telephone lines. When the vehicle is parked in a parking lot or accommodated in a repair shop, a wired communication method can be used instead of the wireless communication method.

Alternatively, the communication line may be a combination of the wireless communication line and the wired communication line. For example, the electronic control system 100 and a base station device in a cellular system may be connected by a wireless communication system such as 4G. The base station device and the distributed ledger 200 or the certificate authority 300 may be connected by a wired communication system such as a backbone line of a telecommunications carrier or the Internet. A gateway device may be provided at a point of contact between the backbone line and the Internet. In addition, communication between the distributed ledger 200 and the certificate authority 300 can be performed using any line, including the Internet.

### (2) Overall Configuration of Electronic Control System

FIG. 2 is a diagram showing a configuration example of the electronic control system 100. The electronic control system 100 includes multiple ECUs including an external communication ECU and an integrated ECU. FIG. 2 illustrates one external communication ECU, one integrated ECU, and four individual ECUs. The electronic control system 100 may include any number of ECUs. The term “ECU” is used as a generic term for the external communication ECU, the integrated ECU, and the individual ECUs.

The external communication ECU is an ECU that communicates with the outside. The communication method used by the external communication ECU is as described in the above-mentioned wireless communication method and wired communication method. In order to implement multiple communication systems, multiple external communication ECUs may be provided.

The integrated ECU is an ECU having a gateway function that mediates between individual ECUs and the external communication ECU. The integrated ECU may be provided with a function for controlling the entire electronic control system 100, for example, a security function. The integrated ECU may be referred to as a gateway ECU (G-ECU) or a mobility computer (MC). Further, the integrated ECU may be a relay device or a gateway device.

The individual ECUs of the electronic control system 100 may be ECUs having arbitrary functions. Examples of individual ECUs include a drive system electronic control unit that controls an engine, a steering wheel, a brake, and the like, a vehicle body system electronic control unit that controls a meter, a power window, and the like, an information system electronic control unit such as a navigation device, and a safety control system electronic control unit that performs control for preventing a collision with an obstacle or a pedestrian. Further, the ECUs may be classified into masters and slaves instead of being parallel to each other.

The ECU may be a physically independent ECU, or may be a virtual ECU (or may be called a virtual machine), which is virtually implemented.

In the case of FIG. 2, the ECUs are connected to one another via an in-vehicle communication network such as controller area network (CAN) and local interconnect network (LIN). Alternatively, the connection may be made using any communication method, whether wired or wireless, such as Ethernet (registered trademark), Wi-Fi (registered trademark), or Bluetooth (registered trademark). The term “connection” refers to a state in which data can be exchanged. This state includes a case in which different hardware devices are connected through a wired or wireless communication network, as well as a case in which virtual machines running on the same hardware are virtually connected with one another.

### (3) Overview of Each Embodiment

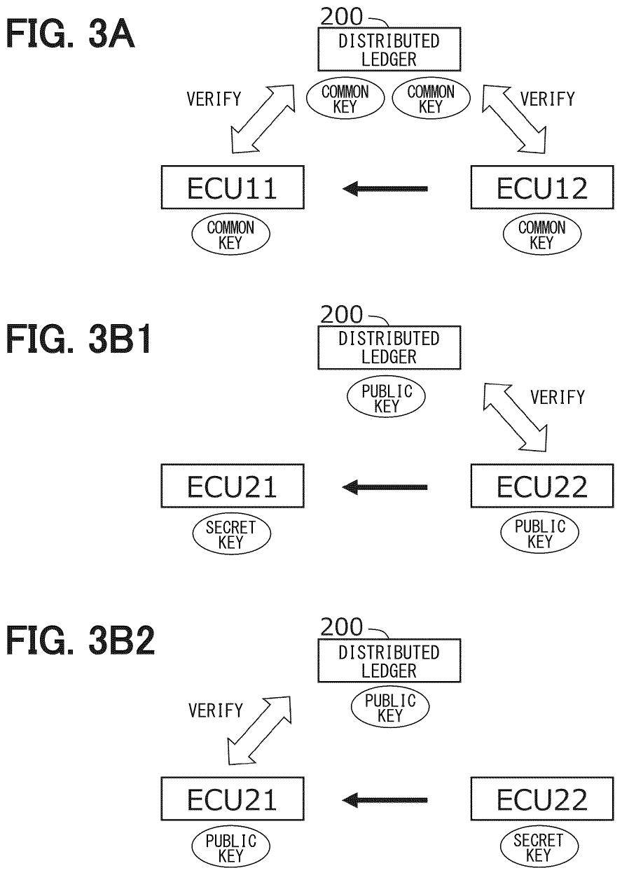

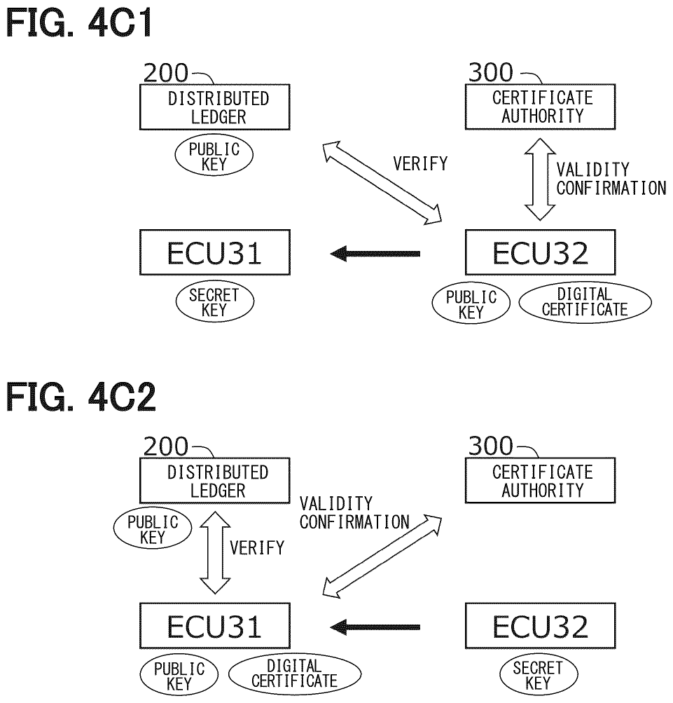

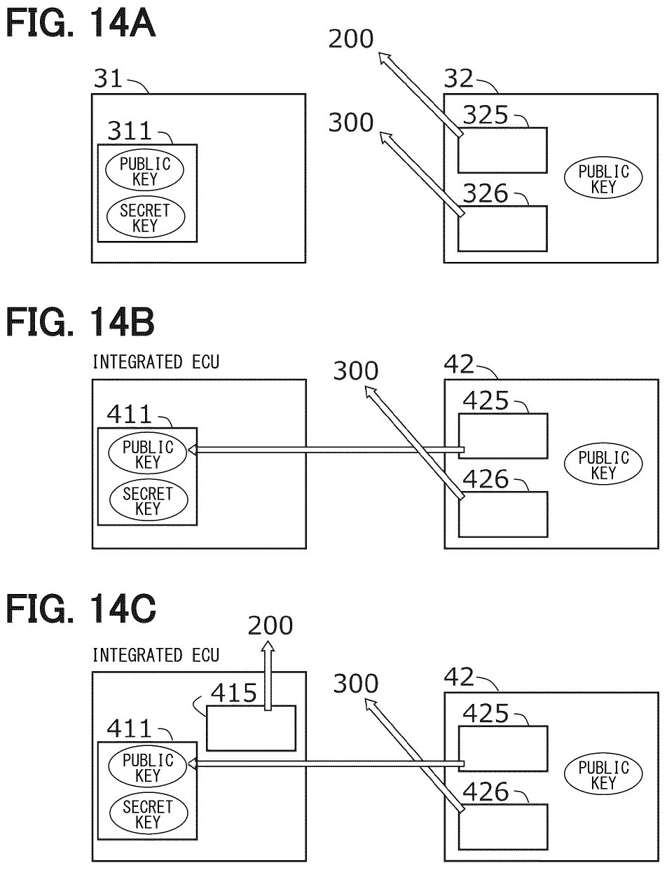

FIGS. 3A to 3B2 and FIGS. 4C1 and 4C2 are diagrams showing the overview of the features of each embodiment. FIG. 3A corresponds to the first embodiment. In the first embodiment, an ECU 11 and an ECU 12 each compare a common key used when transmitting and receiving data between the ECU 11 and the ECU 12 with key information stored in the distributed ledger 200. FIGS. 3B1 and 3B2 correspond to the second embodiment. In the second embodiment, an ECU 21 or an ECU 22 compares the public key used when transmitting and receiving data between the ECU 21 and the ECU 22 with the key information stored in the distributed ledger 200. FIGS. 4C1 and 4C2 correspond to the third embodiment. In the third embodiment, in addition to the configuration of the second embodiment shown in FIGS. 3B1 and 3B2, an ECU 31 or an ECU 32 confirms the validity of the digital certificate with the certificate authority. The overview of the features of the fourth embodiment will be described separately with reference to FIGS. 14A, 14B, and 14C.

### 2. First Embodiment

### (1) Configuration of Electronic Control Units (ECUs)

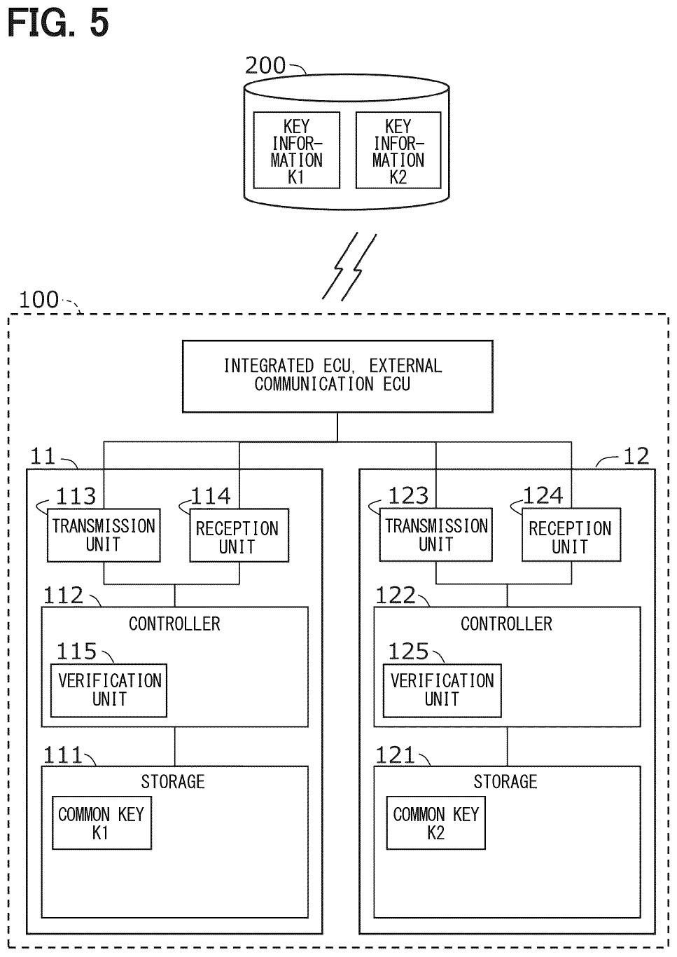

The configurations of the ECU 11 and the ECU 12 in the present embodiment will be described with reference to FIG. 5. The present embodiment corresponds to FIG. 3A.

The ECU 11 and the ECU 12 may be any combination of the ECUs shown in FIG. 2, but in the present embodiment, the ECUs 11 and 12 are individual ECUs connected via the integrated ECU. The ECU 11 includes a storage 111, a controller 112, a transmission unit 113, and a reception unit 114. The controller 112 also includes a verification unit 115. The ECU 12 includes a storage 121, a controller 122, a transmission unit 123, and a reception unit 124. The controller 122 also includes a verification unit 125.

The ECUs 11 and 12 may include a general-purpose central processing unit (CPU), a volatile memory such as a RAM, a non-volatile memory such as a ROM, a flash memory, or a hard disk, various interfaces, and an internal bus connecting the constituents to each other. By executing software on the hardware, functions of the functional blocks illustrated in FIG. 5 can be implemented. Of course, the ECUs 11 and 12 may be implemented by dedicated hardware such as an LSI. The same applies to the ECUs of the other embodiments.

In the present embodiment, the ECUs 11 and 12 are assumed to be semi-finished electronic control units, but are not limited to this. For example, a form of a component may be a semiconductor circuit or a semiconductor module, and a form of a finished product may be a personal computer (PC), a smartphone, a cellular phone, or a navigation system. The same applies to the ECUs of the other embodiments.

Hereinafter, the blocks of the ECU 12 corresponding to the blocks of the ECU 11 will be described as representative of the ECU 11, except when the blocks have different operations or functions. For each block of the ECU 12, the description of the blocks of the ECU 11 is cited.

The storages 111 and 121 respectively store common keys K1 and K2 as “keys.” Although the common key K1 and common key K2 are the same key, they are stored in different storages and falsifying with one of them can result in a different key. Therefore, different symbols are used here to distinguish them. Here, the “key” is data for controlling the procedure of a cryptographic algorithm, and is used not only for encryption, but also for digital signatures, message authentication codes (such as keyed hash), and the like. A seed used in pseudorandom numbers is also a type of key. Furthermore, the “key” stored in the storage may be a key used by this electronic control unit, or may be a key used by another electronic control unit, or the like. The “key” includes, for example, a common key, a secret key, and a public key. Moreover, the key may be a newly generated key or a new key obtained by updating an old key. The key may have an expiration date.

The controller 112 controls the operations of the storage 111, the transmission unit 113, and the reception unit 114. The controller 112 is configured to build the verification unit 115. In addition, the controller 112 uses the common key K1 read from the storage 111 to decrypt encrypted data transmitted from the ECU 12 to the ECU 11, generate a message authentication code, and compare it with a received message authentication code. The controller 122 uses the common key K2 read from the storage 121 to encrypt data to be transmitted from the ECU 12 to the ECU 11 and to generate a message authentication code.

The transmission unit 113 transmits data and the like to the ECU 12 and other ECUs in the electronic control system 100. In addition, data and the like are transmitted to the distributed ledger 200 and other devices via the external communication ECU.

The reception unit 114 receives data and the like from the ECU 12 and other ECUs in the electronic control system 100. Further, it also receives data from the distributed ledger 200 and other devices via the external communication ECU.

The verification unit 115 “verifies” the common key K1 stored in the storage 111 with the “key information” K1 stored in the distributed ledger 200 at a “predetermined timing”. Similarly, the verification unit 125 “verifies” the common key K2 stored in the storage 121 with the “key information” K2 stored in the distributed ledger 200 at a “predetermined timing”. The verification result by the verification unit 115 may be stored in the storages 111 and 121. The details of the verification unit 115 will be described in the next section. Here, the “predetermined timing” may be any time index based on a predetermined rule, and may be expressed, for example, by time, duration, clock count, counter, cycle, or frequency. Furthermore, in addition to a fixed value, the value may be a variable value that varies depending on conditions. The “key information” may be information about the key itself, or it may be the key itself. The term of “verify” includes not only direct verification of the identity of keys, but also indirect verification of whether key information, which is information related to the key, originates from the key.

### (2) Details of Verification Unit

### (a) Reason for Providing Verification Unit

The controller 122 of the ECU 12 encrypts the data to be transmitted to the ECU 11 using the common key K2 read from the storage 121. The transmission unit 123 transmits the encrypted data to the ECU 11 via the integrated ECU. The reception unit 114 of the ECU 11 receives the encrypted data. Then, the controller 112 decrypts the encrypted data using the common key K1 read from the storage 111.

In a case of transmitting and receiving such data, when the common key K1 is falsified by hacking or the like, it will be impossible to decrypt the originally required data. Furthermore, when the common keys K1 and K2 are falsified by hacking or the like, counterfeit data is likely to be decrypted and used. To prevent this, in the present embodiment, the common key K1 is compared with the key information K1 stored in the distributed ledger 200 to confirm whether it has been rewritten by hacking or the like.

By managing the common key K1 using the distributed ledger 200 provided outside the electronic control system 100, rather than managing the common key K1 only within the electronic control system 100, the falsifying of the common key K1 becomes difficult. In other words, when the falsifying of the common key K1 is attempted, not only the hacking of the electronic control system 100 but also the hacking of the distributed ledger 200 are necessary. Furthermore, by storing the key information K1 in the distributed ledger 200 rather than in a normal server or a cloud server, based on the characteristics of blockchain, the key information K1 becomes less susceptible to falsifying. At the same time, even when the falsifying occurs, it becomes easier to detect the falsifying.

### (b) Key Information Stored in Distributed Ledger

The key information K1 stored in the distributed ledger 200 is information related to the key K1. The key information K1 may be any information sufficient to verify the identity of the key K1. For example, the serial number of the common key K1, the MAC value of the serial number, the MAC value of the common key K1, and attribute information of the common key K1 are included. Of course, the key information K1 may be the common key K1 itself.

The method of registering the key information K1 in the distributed ledger 200, i.e., the method of storing the key information K1 in the distributed ledger 200, is arbitrary, but several examples will be described below.

As a first example, the ECU 11 itself may transmit the key information K1 to the distributed ledger 200. That is, the controller 112 may read the common key K1 from the storage 111 and transmit the common key K1 from the transmission unit 113, or the controller 112 may obtain the serial number of the common key K1, the MAC value of the common key, or the like, and transmit them. When transmitting, the data may be transmitted directly to the distributed ledger 200 or indirectly to the distributed ledger 200. In other words, information may be transmitted from the transmission unit 113 to other ECUs in the electronic control system 100 (for example, a DCM (Data Communication Module) or other ECUs within the vehicle), and information may be transmitted from the other ECUs to the distributed ledger 200. Also, the communication may be performed via other external devices such as a server, a relay device, or the certificate authority 300. The distributed ledger 200 that receives the key information K1 may store the received key information K1 as is, or may calculate and store, for example, the serial number of the common key K1 or the MAC value of the common key K1 from the received common key K1.

As a second example, when a vehicle is registered or repaired, a vehicle manufacturer, dealer, repair shop, or the like may write the common key K1 and key information K1 to the ECU 11 and the distributed ledger 200 from a computer or the like that they manage.

As a third example, the integrated ECU or the like of the electronic control system 100 may transmit the common key K1 and the key information K1 to the ECU 11 and the distributed ledger 200.

### (c) Mode of Verification

The verification between the common key K1 stored in the storage 111 and the key information K1 stored in the distributed ledger 200 may be performed by the ECU 11 itself or by another device.

When performed by the ECU 11 itself, the controller 112 reads out the common key K1 from the storage 111, and the reception unit 114 receives the key information K1 transmitted from the distributed ledger 200 in response to a request for key information transmitted from the transmission unit 113 based on instructions from the controller 112. Then, the verification unit 115 compares the common key K1 with the key information K1, and verifies whether the common key K1 has been falsified based on whether there is a common point that the common key K1 and the key information K1 should have.

An example of a case where the verification is performed by another device is that the verification is performed by a device that manages the distributed ledger 200. Based on an instruction from the controller 112 of the ECU 11, the transmission unit 113 generates key information K1 from the common key K1 stored in the storage 111 and transmits the generated key information K1. Then, the device managing the distributed ledger 200 compares the key information K1 stored in the distributed ledger 200 with the key information K1 transmitted from the ECU 11 to verify it, and transmits the result to the ECU 11. The ECU 11 receives the result at the reception unit 114 and confirms the result at the verification unit 115. Examples of devices other than the device that manages the distributed ledger 200 include other external devices and ECUs other than ECU 11, including ECU 12.

### (d) Timing of Verification

In order to detect falsifying caused by cyber attacks, it is desirable for the ECU 11 to perform the verification every time it receives encrypted data from the ECU 12. However, the number of communications between the ECUs mounted in the electronic control system 100 is very high, for example, 10 or more times per second. Moreover, since the vehicle equipped with the electronic control system 100 is moving, communication with the outside is not necessarily stable at all times. Therefore, when the distributed ledger 200 is confirmed every time communication between ECUs occurs, the communication volume will increase and the communication lines will become saturated. Therefore, execution of the verification itself may become difficult. In addition, the communication with the outside is not performed while the vehicle is parked. Therefore, the verification is impossible. It is desirable to perform the verification as soon as communication with the outside is restored. Therefore, the verification unit 115 performs verification at a predetermined timing. Hereinafter, the predetermined timing will be exemplified.

### First Example

While the vehicle is traveling, when the electronic control system 100 installed in the vehicle is capable of communicating with the outside, the verification is performed once or multiple times at a predetermined time interval (corresponding to a “first predetermined time”), or once or multiple times when the number of communications between the ECU 11 and other ECUs in the electronic control system 100 is a predetermined number of communications (corresponding to a “first predetermined time”). In other words, the verification may be performed either in synchronization with the timing of communication between the ECU 11 and other ECUs, or asynchronously. According to the above configuration, it is possible to prevent an increase in the amount of communication with the distributed ledger 200 and saturation of the communication line. Thereby, it is possible to more stably perform the verification of the common key K1.

Moreover, the predetermined time or the predetermined number of communications may be determined according to the speed of the vehicle. That is, the predetermined time or the predetermined number of communications may vary with the speed of the vehicle. When the vehicle speed is high, the amount of communication between the ECUs is generally high, and when the vehicle speed is low, the amount of communication between the ECUs is generally low. Therefore, the faster the vehicle speed, the shorter the predetermined time should be. For example, when the speed is high (for example, 40 km/h or higher), the predetermined time may be 1 second, and when the speed is low (for example, 10 km/h or lower), the predetermined time may be 3 seconds. Alternatively, the predetermined time may be set for each of low speed, medium speed, high speed, and the like. The number of speed setting division is arbitrary. Alternatively, the predetermined time may be changed continuously without division. According to the above configuration, it is possible to reduce and equalize the risks of cyber attacks and the damage caused by them. In particular, it is possible to prevent excessive use of resources required for communication with the outside.

### Second Example

When the electronic control system 100 installed in the vehicle does not communicate with the outside for a predetermined time (corresponding to a “second predetermined time”) or more, the electronic control system 100 performs the verification within a predetermined time (corresponding to a “third predetermined time”) after resuming communication with the outside. Examples of resumption of communication include the start of communication after a communication interruption is resolved, as well as the start of communication accompanying startup of the vehicle, such as starting the engine. This also includes the case where communication started with a new external device. The second predetermined time is an arbitrary time such as 5 minutes or 10 minutes. The third predetermined time is, for example, within an arbitrary time such as within 1 second or within 3 seconds from the start of communication with the outside. The shorter time is preferable. According to the above configuration, the verification can be performed quickly when communication is restored after the communication interruption when verification is not possible, or when the startup vehicle whose system is unstable and vulnerable to cyber attacks occurs.

### Third Example

When the vehicle is parked, the electronic control system 100 installed in the vehicle can communicate with the outside at a predetermined time (corresponding to a “fourth predetermined time”). When the vehicle is parked, the engine is turned off. Vehicles are often left unattended while parked. In contrast to cyber attacks, hacking or other attacks is likely to be performed by suspicious individuals through physical connections. Therefore, it is desirable to perform the verification periodically even while the vehicle is parked. The fourth predetermined time period is an arbitrary time period, such as one hour or two hours. Since the risk of loss of control of the vehicle is low, unlike when the vehicle is moving, the fourth predetermined time can be set to a time longer than the first predetermined time and the second predetermined time. Since communication is required even when the engine is off, it is desirable to perform communication using a communication method with low power consumption, such as low power wide area (LPWA). According to the above configuration, even when the vehicle is parked, it is possible to perform the verification in anticipation of a possible attack on the electronic control system 100.

### (e) Vehicle Communication State

The predetermined timing may be determined according to the communication state of the vehicle. The communication state of the vehicle may change depending on, for example, the traveling state (including whether the vehicle is stopped or parked), the traveling location, the traveling speed, and the like. Furthermore, when multiple wireless communication methods are used for communication with the outside, the wireless communication method to be used can be changed. For example, the frequency of verification when a line with a high communication speed is used may be set to be higher than the frequency of verification when a line with a low communication speed is used. Thereby, it is possible to avoid saturation of the communication line. Alternatively, the frequency of verification may be set higher when a free or low-cost line is used than when a high-cost line is used. Alternatively, when the same line is used continuously, the frequency of verification may be changed according to the response speed of the line, the S/N ratio, the strength of the radio wave reception, or the like.

### (f) Verification in Electronic Control System

Although the above description focuses on the ECU 11, as shown in FIG. 2, the electronic control system 100 mounted on a vehicle usually includes multiple ECUs. Each of the ECUs included in the electronic control system 100 individually performs the above-described verification. However, it is not necessary for all ECUs included in the electronic control system 100 to perform the verification.

The predetermined timing for each ECU may be different. For example, it is desirable that the frequency of the predetermined timing of the external communication ECU (corresponding to a “first electronic control unit”) that serves as the entry point is higher than the frequency of the predetermined timing of another ECU (corresponding to the “second electronic control unit”). Thereby, it is possible to increase the security level of external communication ECUs, which are at high risk of cyber attacks. Alternatively, it is desirable that the frequency of the predetermined timing of the ECU that controls automated driving and the drive system ECU (corresponding to the “first electronic control unit”) is higher than the frequency of the predetermined timing of other ECUs (corresponding to the “second electronic control unit”). Thereby, it is possible to prevent the dangers of cyber attacks from becoming apparent. Alternatively, it is desirable that the frequency of the predetermined timing in an ECU (corresponding to the “first electronic control unit”) that has a large amount of communication or frequency of communication within the vehicle is higher than the frequency of the predetermined timing in the different ECUs (corresponding to “second electronic control unit”). For example, since the integrated ECU has a gateway function, the amount of communication is greater than that of the different ECU. Thereby, it is possible to improve the reliability of each communication within the vehicle.

### (4) Others

In the above description of the verification unit 115, the common key K1 is used to decrypt encrypted data, but it may be used for other purposes such as message authentication. Furthermore, the verification may be performed synchronously or asynchronously with the transmission and reception of data. Furthermore, the above description of the verification unit 115 has been given with a focus on the ECU 11 and the common key K1 that decrypt the encrypted data. However, the same applies to the ECU 12 and the common key K2 that encrypt data, and in this case, the description of the ECU 12 and the common key K2 should be read as such. In addition to the key information, the distributed ledger 200 may store a vehicle ID that identifies the vehicle and an ECU ID that identifies the ECU. When obtaining key information from the distributed ledger, the vehicle ID or ECU ID may be specified. The above description of the verification unit 115 can be applied not only to the present embodiment but also to other embodiments. In other embodiments, the secret key and the public key are used, so the description of the common key K1 should be read as a public key Pn (n is an integer).

### (3) Operation of Electronic Control Units (ECUs)

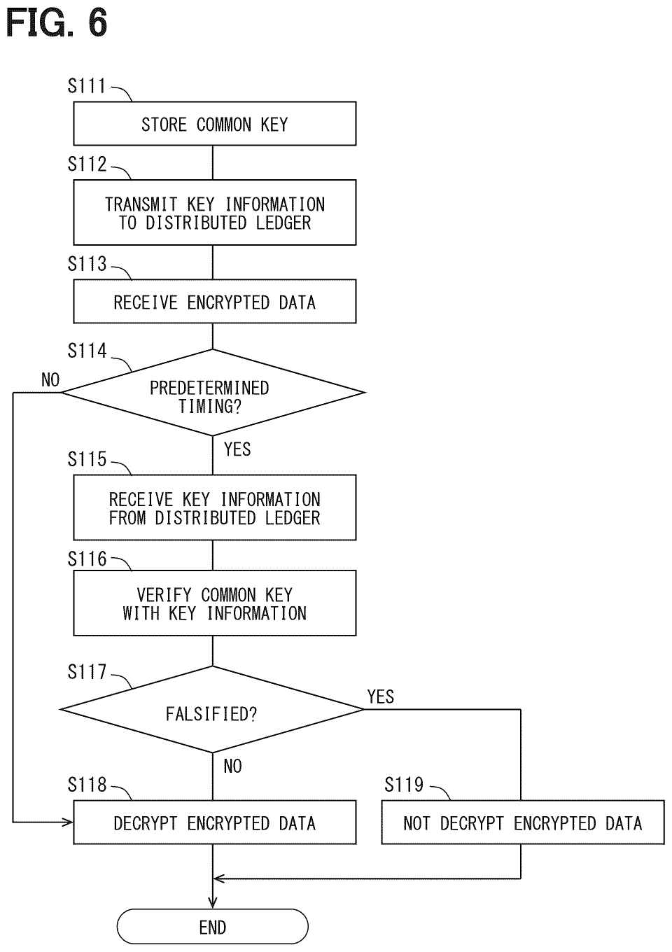

The operations of verifying the common key K1 and decrypting received data in the ECU 11 of the present embodiment will be described with reference to the flowchart of FIG. 6. The following operations not only show a key verification method executed by the ECU 11 but also show the processing procedures of the key verification program executable by the ECU 11. The order of the processes is not limited to the example shown in FIG. 6. That is, the order may be interchanged as long as there are no restrictions, such as a relationship in which one process uses the results of its prior process. The above also applies to flowcharts other than FIG. 6 in all the embodiments.

The ECU 11 stores the common key K1 in the storage 111 (S111). The transmission unit 113 of the ECU 11 transmits the key information K1, which is information about the common key K1 stored in the storage 111, to the distributed ledger 200 (S112). Thereafter, at any timing, the reception unit 114 of the ECU 11 receives the encrypted data (S113). For example, when the common keys K1 and K2 are the same key, the reception unit 114 of the ECU 11 receives data encrypted by the ECU 12 using the common key K2.

The verification unit 115 determines whether it is a predetermined timing (S114). When it is determined that it is the predetermined timing (S114: YES), the transmission unit 113 transmits a request for key information to the distributed ledger 200, and the reception unit 114 receives the key information K1 transmitted from the distributed ledger 200 (S115). The verification unit 115 verifies the common key K1 read from the storage 111 with the key information K1 received from the distributed ledger 200 (S116). When it is determined that the common key K1 has not been falsified (S117: YES), the encrypted data received in S113 is decrypted using the common key K1 (S118). When it is determined that the common key K1 has been falsified (S117: NO), the encrypted data received in S113 is not decrypted (S119). When it is not determined that the predetermined timing has arrived (S114: NO), the encrypted data received in S113 is decrypted (S118).

As already described, it is not necessarily the ECU 11 that transmits the key information K1, which is information related to the common key K1, to the distributed ledger 200, so S112 is an optional step in the present embodiment. Further, the decoding may involve decoding all of the data transmitted and received between the ECUs, or it may involve decoding only a portion of the data, for example, the data portion of an Ethernet frame. Furthermore, in FIG. 6, the predetermined timing is synchronized with the decryption of the encrypted data, but it may be asynchronous. For example, the verification result by the verification unit 115 may be stored in the storage 111, and when decrypting encrypted data using the common key K1, the verification result may be read from the storage 111, and the controller 112 may determine whether to use the common key K1 based on the verification result.

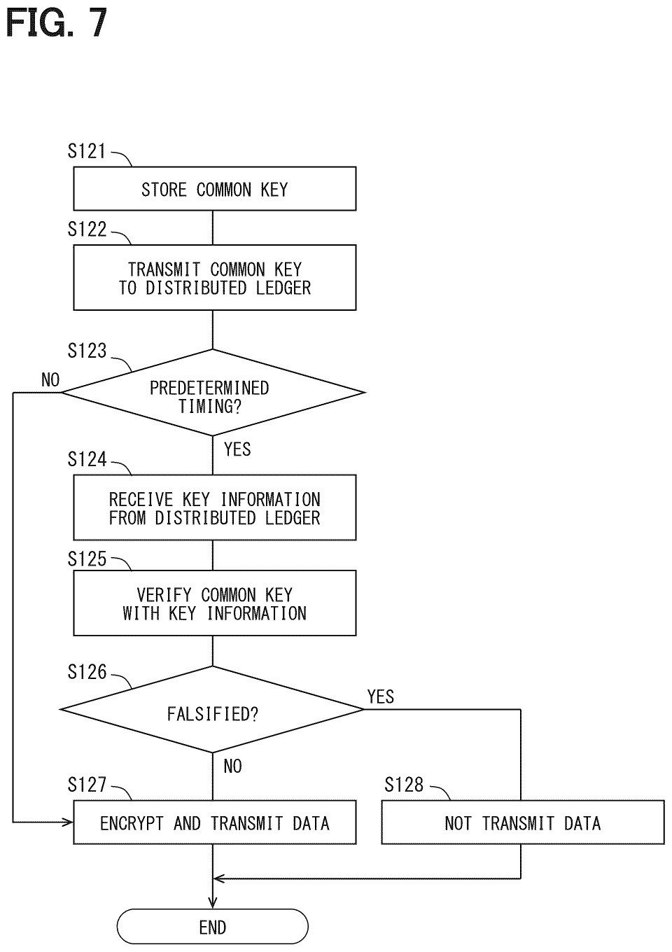

The operation of verifying the common key K2 and encrypting transmission data in the ECU 12 of the present embodiment will be described with reference to the flowchart of FIG. 7.

The ECU 12 stores the common key K2 in the storage 121 (S121). The transmission unit 123 of the ECU 12 transmits the key information K2, which is information about the common key K2 stored in the storage 121, to the distributed ledger 200 (S122).

The verification unit 125 determines whether it is a predetermined timing (S123). When it is determined that it is the predetermined timing (S123: YES), the transmission unit 123 transmits a request for key information to the distributed ledger 200, and the reception unit 124 receives the key information K2 transmitted from the distributed ledger 200 (S124). The verification unit 125 verifies the common key K2 read from the storage 121 with the key information K2 received from the distributed ledger 200 (S125). When it is determined that the common key K2 has not been falsified (S126: YES), the data is encrypted using the common key K2 and transmitted (S127). When it is determined that the common key K2 has been falsified (S126: NO), the data is not encrypted and is not transmitted (S128). When it is not determined that the predetermined timing has arrived (S123: NO), the data is encrypted and then transmitted (S127).

As already described, the ECU that transmits the key information K2, which is information related to the common key K2, to the distributed ledger 200 is not necessarily the ECU 12, so S122 is an optional step in the present embodiment. Further, the encryption may encrypt all of the data transmitted between the ECUs, or may encrypt only a portion of the data, for example, the data portion of an Ethernet frame. Furthermore, in FIG. 7, the predetermined timing is synchronized with the encryption and transmission of data, but it may be asynchronous. For example, the verification result by the verification unit 125 may be stored in the storage 121, and when encrypting data using the common key K2, the verification result may be read from the storage 121, and the controller 122 may determine whether to use the common key K2 based on the verification result.

### (4) Short Overview

As described above, according to the present embodiment, the key information K1 and the key information K2 are stored in the distributed ledger and compared with the common key K1 and the common key K2, so that falsifying of the common key K1 and the common key K2 can be detected more accurately. Further, according to the present embodiment, the common key K1 and the key information K1, and the common key K2 and the key information K2 are verified at a predetermined timing. Therefore, it is possible to prevent the amount of communication with the distributed ledger 200 from increasing and saturating the communication line. Thereby, it is possible to more stably verify the common keys K1 and K2. As a result, it is possible to ensure the security of the common keys K1 and K2.

### 3. Second Embodiment

### (1) Configuration of Electronic Control Units (ECUs)

In the first embodiment, data is transmitted and received in the electronic control system 100 using the common key. The present embodiment differs from the first embodiment in that the secret key and the public key are used instead of the common key. Only the differences from the first embodiment will be described below, and the same parts as the first embodiment will be described citing the description of the first embodiment.

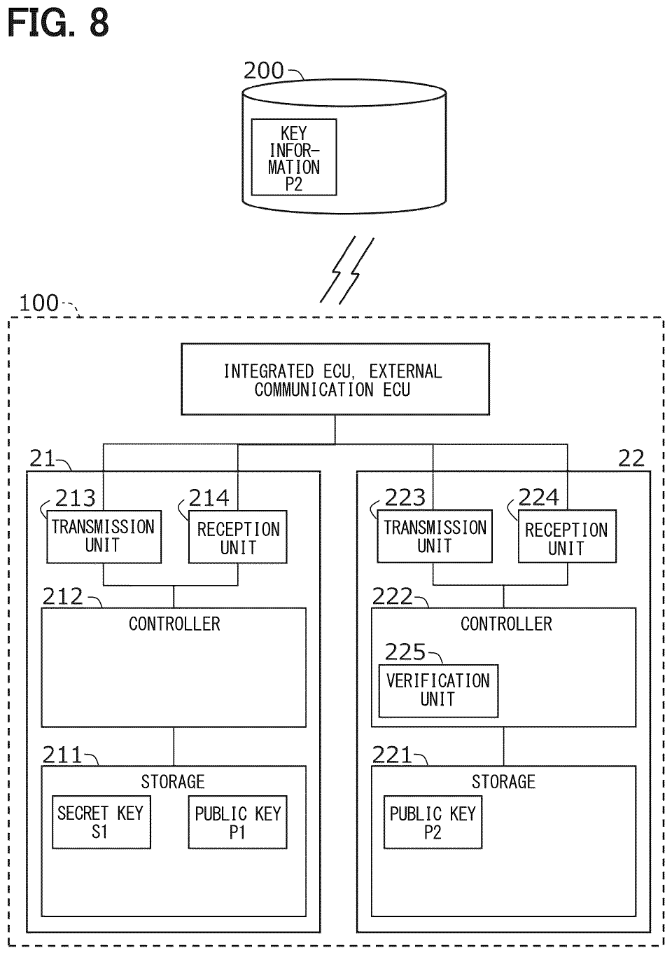

The configurations of the ECU 21 and the ECU 22 in the present embodiment will be described with reference to FIG. 8. The present embodiment corresponds to FIG. 3B1.

The ECU 21 and the ECU 22 may be any combination of the ECUs shown in FIG. 2, but in the present embodiment, the ECUs are individual ECUs connected via an integrated ECU. The ECU 21 includes a storage 211, a controller 212, a transmission unit 213, and a reception unit 214. The ECU 22 includes a storage 221, a controller 222, a transmission unit 223, and a reception unit 224. Further, the controller 222 also includes a verification unit 225.

The storage 221 stores a public key P2. The storage 211 stores a secret key S1 and a public key P1. The public key P2 and public key P1 are the same key, but are stored in different storages, and falsifying of one of them can result in a different key, so different symbols are used here to distinguish them.

In the present embodiment, the ECU 21 generates the public key P1 using the secret key S1. Then, the transmission unit 213 transmits the public key P1 to the ECU 22, and the reception unit 224 of the ECU 22 receives the public key P1. The ECU 22 that receives the public key stores the public key P1 in the storage 221 as the public key P2.

In the present embodiment, the controller 222 of the ECU 22 encrypts the data to be transmitted to the ECU 21 using the public key P2 read from the storage 221. The transmission unit 223 transmits the encrypted data to the ECU 21 via the integrated ECU. The reception unit 214 of the ECU 21 receives the encrypted data. Then, the controller 212 decrypts the encrypted data using the secret key S1 read from the storage 211.

The verification unit 225 of the ECU 22 verifies the public key P2 stored in the storage 221 with the key information P2 stored in the distributed ledger 200 at a predetermined timing. The details of the verification unit 225 are similar to the details of the verification unit 115 described in the first embodiment, except that the verification unit 225 uses public key P2 and key information P2. Therefore, the description of the first embodiment will be cited based on the premise of the present embodiment, and the explanation will be omitted. Of course, the ECU 21 also has the public key P1, but the purpose of this is to distribute it to the different ECU or the like, and the ECU 21 does not normally use the public key P1. Therefore, the controller 212 does not include the verification unit. However, similar to the first embodiment, the ECU 21 may also be provided with a verification unit 215 to verify the public key P1 stored in the storage 211 with the key information P1 stored in the distributed ledger 200.

The operation of the ECU 22 is similar to that of the ECU 12 in the first embodiment and FIG. 7, so the description of the first embodiment will be cited and reinterpreted on the premise of the present embodiment, and a description thereof will be omitted.

### (2) Modification

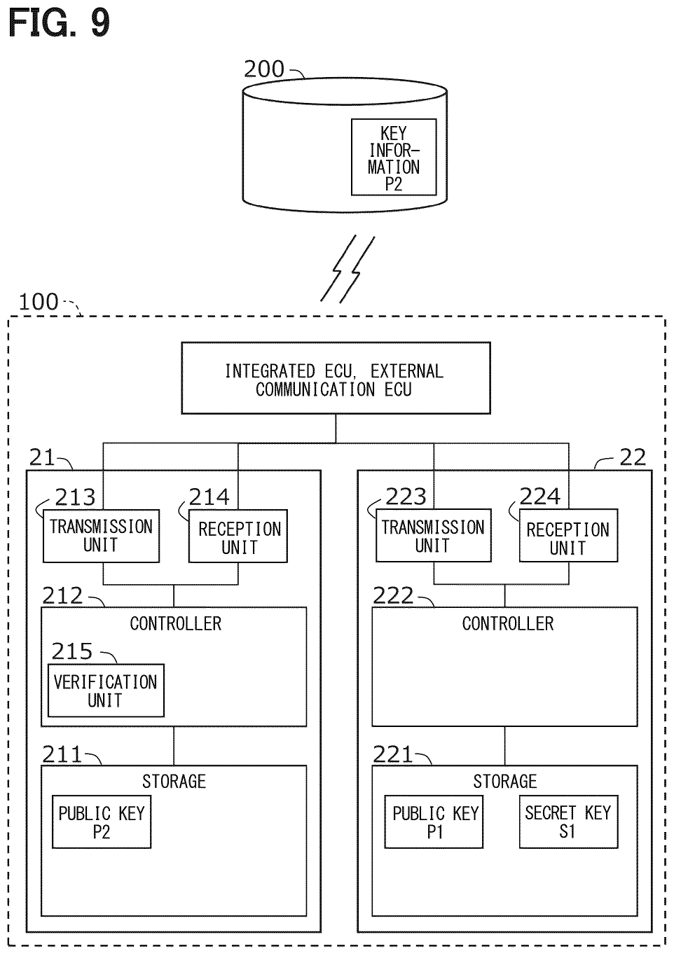

FIG. 9 shows the configuration of the ECU 21 and the ECU 22 in the modification of the present embodiment, and corresponds to FIG. 3B2.

The ECU 21 and the ECU 22 may be any combination of the ECUs shown in FIG. 2, but in the present embodiment, the ECUs are individual ECUs connected via an integrated ECU. The ECU 21 has the storage 211, the controller 212, the transmission unit 213, and the reception unit 214. The controller 212 also includes the verification unit 215. The ECU 22 has the storage 221, the controller 222, the transmission unit 223, and the reception unit 224.

The storage 221 stores the secret key S1 and the public key P1. The storage 211 stores the public key P2. The public key P1 and public key P2 are the same key, but are stored in different storages, and falsifying of one of them can result in a different key, so different symbols are used here to distinguish them.

In the present modification, the ECU 22 generates the public key P1 using the secret key S1. Then, the transmission unit 223 transmits the public key P1 to the ECU 21, and the reception unit 214 of the ECU 21 receives the public key P1. The ECU 21 that receives the public key stores the public key P1 in the storage 211 as the public key P2.

In the present embodiment, the controller 222 of the ECU 22 generates an digital signature for data to be transmitted to the ECU 21 using the secret key S1 read from the storage 221. The transmission unit 223 transmits the data and the digital signature to the ECU 21 via the integrated ECU. The reception unit 214 of the ECU 21 receives the data and the digital signature. Then, the controller 212 decrypts the digital signature using the public key P2 read from the storage 211.

The verification unit 215 of the ECU 21 verifies the public key P2 stored in the storage 211 with the key information P2 stored in the distributed ledger 200 at a predetermined timing. The details of the verification unit 215 are similar to the details of the verification unit 115 described in the first embodiment, except that the verification unit 215 uses the public key P2 and key information P2. Therefore, the description of the first embodiment will be cited based on the premise of the present embodiment, and the explanation will be omitted. Of course, the ECU 22 also has the public key P1, but the purpose of this is to distribute it to the different ECU or the like, and the ECU 22 does not normally use the public key P1. Therefore, the controller 222 does not include the verification unit. However, similar to the first embodiment, the ECU 22 may also be provided with the verification unit 225 to verify the public key P1 stored in the storage 221 with the key information P1 stored in the distributed ledger 200.

The operation of the ECU 21 is similar to that of the ECU 11 in the first embodiment and FIG. 6, so the description of the first embodiment will be cited and reinterpreted on the premise of the present embodiment, and a description thereof will be omitted.

### (3) Short Overview

As described above, according to the present embodiment, the key information K1 and the key information K2 are stored in the distributed ledger and compared with the common key K1 and the common key K2, so that falsifying of the common key K1 and the common key K2 can be detected more accurately. In addition, since the public key P2 and the key information P2 are compared at a predetermined timing, it is possible to prevent an increase in the amount of communication with the distributed ledger 200 and saturation of the communication line. Thereby, it is possible to more stably verify the public key P2. As a result, it is possible to ensure the security of the public key P2.

### 4. Third Embodiment

### (1) Configuration of Electronic Control Units (ECUs)

In the present embodiment, in addition to the public key verification in the second embodiment, the digital certificate for the public key is issued and the validity of the digital certificate is confirmed. Hereinafter, only the parts added to and the parts different from the second embodiment will be described, and the description of the second embodiment will be cited for the parts that are the same as the second embodiment.

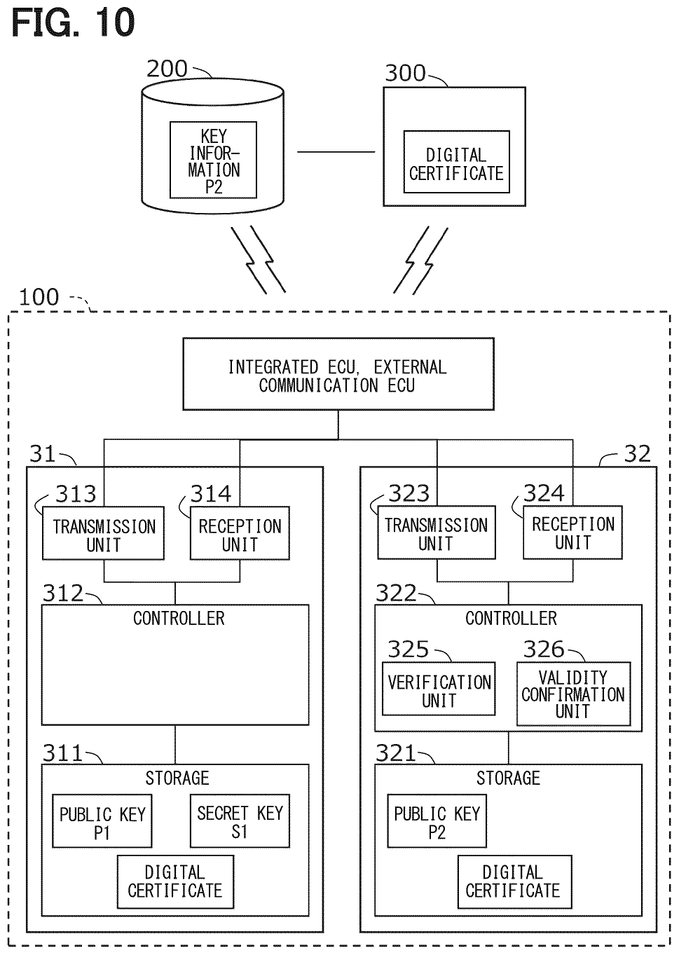

The configurations of the ECUs 31 and 32 in the present embodiment will be described with reference to FIG. 10. The present embodiment corresponds to FIG. 4C1.

The ECU 31 and the ECU 32 may be any combination of the ECUs shown in FIG. 2, but in the present embodiment, they are individual ECUs connected via an integrated ECU. The ECU 31 has a storage 311, a controller 312, a transmission unit 313, and a reception unit 314. The ECU 32 includes a storage 321, a controller 322, a transmission unit 323, and a reception unit 324. The controller 322 also includes a verification unit 325 and a validity confirmation unit 326.

The storage 321 stores the public key P2. The storage 311 stores the secret key S1 and the public key P1. The public key P2 and public key P1 are the same key, but are stored in different storages, and falsifying with one of them can result in a different key, so different symbols are used here to distinguish them.

In the present embodiment, similarly to the second embodiment, the ECU 31 generates the public key P1 using the secret key S1. Then, the transmission unit 313 transmits the public key P1 to the ECU 32, and the reception unit 324 of the ECU 32 receives the public key P1. The ECU 32 that receives the public key stores the public key P1 in the storage 321 as the public key P2.

Furthermore, in the present embodiment, the ECU 31 transmits the generated public key P1 from the transmission unit 313 to the certificate authority 300, and the certificate authority 300 issues the digital certificate for the public key P1 and transmits it to the ECU 31. The digital certificate is a certificate that guarantees the public key P1 and the device that owns it. The reception unit 314 of the ECU 31 receives the public key P1 with the digital certificate attached thereto, and stores the digital certificate in the storage 311. Then, the transmission unit 313 of the ECU 31 transmits the digital certificate to the ECU 32, and the reception unit 324 of the ECU 32 receives the digital certificate. The ECU 32 that receives the digital certificate stores the digital certificate in the storage 321. The digital certificate may be transmitted from the ECU 31 to the ECU 32 at the same time as the public key P1 is transmitted. Furthermore, the digital certificate may be transmitted only once at the beginning, or may be sent periodically.

The method for storing the key information P2 in the distributed ledger 200 can be the method exemplified in the first embodiment. However, the certificate authority 300 may transmit the public key P1 to the distributed ledger 200, and the distributed ledger 200 may generate and store the key information P2. Alternatively, the certificate authority 300 may generate and transmit key information P2 from the public key P1, and the distributed ledger 200 may store the key information P2.

In the present embodiment, the controller 322 of the ECU 32 encrypts the data to be transmitted to the ECU 31 using the public key P2 read from the storage 321. The transmission unit 323 transmits the encrypted data to the ECU 31 via the integrated ECU. The reception unit 314 of the ECU 31 receives the encrypted data. Then, the controller 312 decrypts the encrypted data using the secret key S1 read from the storage 311.

The verification unit 325 verifies the public key P2 stored in the storage 321 with the key information P2 stored in the distributed ledger 200 at a predetermined timing. The details of the verification unit 325 are similar to the details of the verification unit 115 described in the first embodiment, except that the verification unit 325 uses public key P2 and key information P2. Therefore, the description of the first embodiment will be cited based on the premise of the present embodiment, and the explanation will be omitted.

The validity confirmation unit 326 confirms the validity of the digital certificate received from the ECU 31. Specifically, the validity confirmation unit 326 transmits, from the transmission unit 323, a confirmation signal to the certificate authority 300 for inquiring about the validity of the digital certificate of the public key P2. Then, the certificate authority 300 that has received the confirmation signal confirms the validity of the digital certificate indicated in the confirmation signal, and transmits the result of the confirmation to the ECU 32. The validity confirmation includes, for example, confirming the authenticity of the digital certificate as well as the expiration date of the digital certificate. The reception unit 324 of the ECU 32 receives the confirmation result.

It is desirable that the “frequency” of validity confirmation by the validity confirmation unit 326 is lower than the “frequency” of the predetermined timing of verification by the verification unit 325. Here, the “frequency” may directly or indirectly indicate the number of times information is transmitted at a predetermined timing, and may be indicated by a period, time, or the like in addition to the number of times.

For example, the frequency of the validation confirmation can be set to coincide with legal vehicle inspections or vehicle inspections, or to a relatively long period such as once a year. Moreover, the frequency of validity confirmation may be set arbitrarily. Alternatively, a time when the vehicle is started or when the vehicle is delivered may be set to the first time. Alternatively, when a failure is detected during verification by the verification unit 325, the validity confirmation may be performed.

### (2) Modification

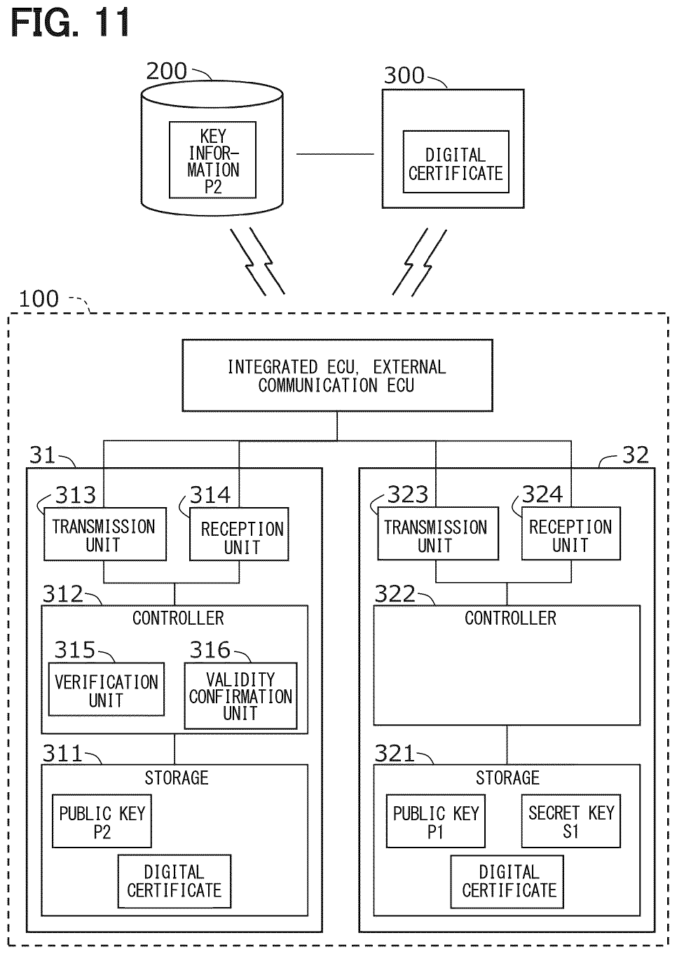

FIG. 11 shows the configuration of the ECU 31 and the ECU 32 in a modification of the present embodiment, and corresponds to FIG. 4C2.

The ECU 31 and the ECU 32 may be any combination of the ECUs shown in FIG. 2, but in the present embodiment, they are individual ECUs connected via the integrated ECU. The ECU 31 includes the storage 311, the controller 312, the transmission unit 313, and the reception unit 314. The controller 312 also includes a verification unit 315 and a validity confirmation unit 316. The ECU 32 includes the storage 321, the controller 322, the transmission unit 323, and the reception unit 324.

The storage 321 stores the secret key S1 and a public key P1. The storage 311 stores the public key P2. The public key P1 and public key P2 are the same key, but may be stored in different storages, and falsifying with one of them can result in a different key. Therefore, different symbols are used here to distinguish them.

In the present embodiment, similarly to the modification of the second embodiment, the ECU 32 generates the public key P1 using the secret key S1. Then, the transmission unit 323 transmits the public key P1 to the ECU 31, and the reception unit 314 of the ECU 31 receives the public key P1. The ECU 31 that receives the public key stores the public key P1 in the storage 311 as the public key P2.

Furthermore, in the present embodiment, the ECU 32 transmits the generated public key P1 from the transmission unit 323 to the certificate authority 300, and the certificate authority 300 issues the digital certificate for the public key P1 and transmits it to the ECU 32. The digital certificate is a certificate that guarantees the public key P1 and the device that owns it. The reception unit 324 of the ECU 32 receives the public key P1 with the digital certificate attached thereto, and stores the digital certificate in the storage 321. Then, the transmission unit 323 of the ECU 32 transmits the digital certificate to the ECU 31, and the reception unit 314 of the ECU 31 receives the digital certificate. The ECU 31 that receives the digital certificate stores the digital certificate in the storage 311. The ECU 32 may transmit the digital certificate to the ECU 31 at the same time as transmitting the public key P1. The digital certificate may be transmitted only once at the beginning, or periodically.

The method for storing the key information P2 in the distributed ledger 200 can be the method exemplified in the first embodiment. However, the certificate authority 300 may transmit the public key P1 to the distributed ledger 200, and the distributed ledger 200 may generate and store the key information P2. Alternatively, the certificate authority 300 may generate and transmit key information P2 from the public key P1, and the distributed ledger 200 may store the key information P2.

In the present embodiment, the controller 322 of the ECU 32 generates a digital signature for data to be transmitted to the ECU 31 using the secret key S1 read from the storage 321. The transmission unit 323 transmits the data and the digital signature to the ECU 31 via the integrated ECU. The reception unit 314 of the ECU 31 receives the data and the digital signature. Then, the controller 312 decrypts the digital signature using the public key P1 read from the storage 311.

The verification unit 315 verifies the public key P2 stored in the storage 311 with the key information P2 stored in the distributed ledger 200 at a predetermined timing. The details of the verification unit 315 are similar to the details of the verification unit 115 described in the first embodiment, except that the verification unit 315 uses the public key P2 and key information P2. Therefore, the description of the first embodiment will be cited based on the premise of the present embodiment, and the explanation will be omitted.

The validity confirmation unit 316 confirms the validity of the digital certificate received from the ECU 32. Specifically, the validity confirmation unit 316 transmits, from the transmission unit 313, a confirmation signal to the certificate authority 300 for inquiring about the validity of the digital certificate of the public key P2. Then, the certificate authority 300 that has received the confirmation signal confirms the validity of the digital certificate indicated in the confirmation signal, and transmits the result of the confirmation to the ECU 31. The validity confirmation includes, for example, confirming the authenticity of the digital certificate as well as the expiration date of the digital certificate. The reception unit 314 of the ECU 31 receives the confirmation result.

### (3) Operation of Electronic Control Units (ECUs)

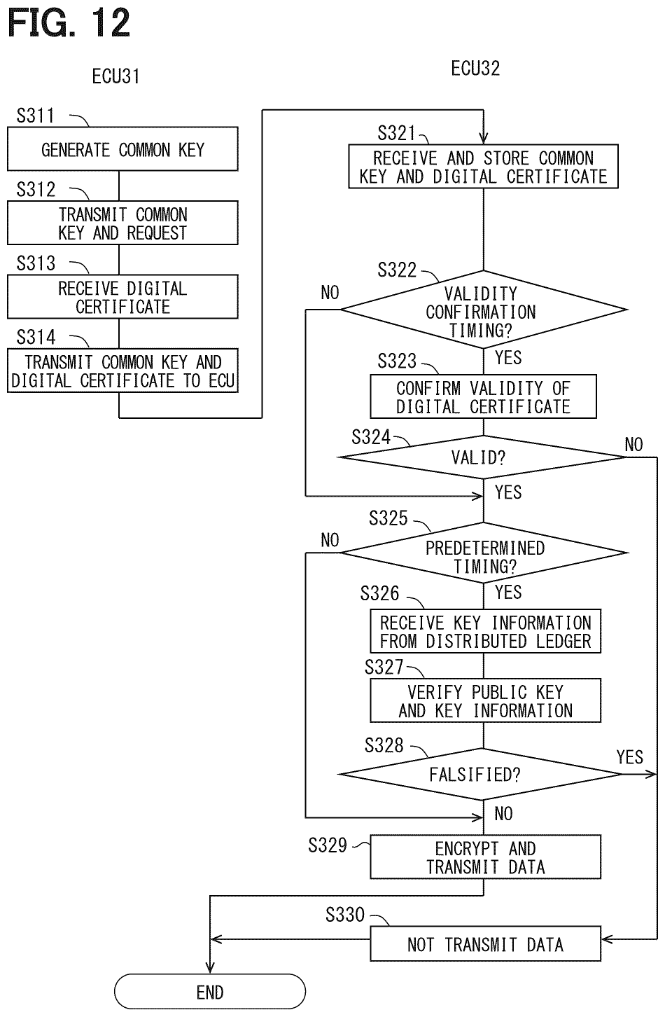

The operation of verifying the public key P2 and encrypting transmission data in the ECU 32 of the present embodiment will be described with reference to the flowchart of FIG. 12.

First, the operation of the ECU 31 will be described. The controller 312 of the ECU 31 generates the public key P1 using the secret key S1 (S311). The transmission unit 313 transmits the generated public key P1 and a request for issuance of a digital certificate to the certificate authority 300 (S312). The reception unit 314 receives the digital certificate issued by the certificate authority 300 (S313). Then, the transmission unit 313 transmits the public key P1 and the digital certificate to the ECU 32 (S314).

Next, the operation of the ECU 32 will be described. The reception unit 324 of the ECU 32 receives the public key P1 and the digital certificate, and stores them in the storage 321 as the public key P2 and the digital certificate (S321). The validity confirmation unit 326 determines whether it is time to confirm the validity of the digital certificate (S322). When it is the timing to confirm the validity of the digital certificate (S322: YES), the validity confirmation unit 326 transmits a confirmation signal to the certificate authority 300 for inquiring about the validity of the digital certificate, and receives the authentication result from the certificate authority 300 (S323). When it is not time to confirm the validity (S322: NO), the process proceeds to a process of determining whether it is a predetermined timing (S325). When the digital certificate is valid (S324: YES), the verification unit 325 determines whether it is the predetermined timing (S325). When it is determined that it is the predetermined timing (S325: YES), the transmission unit 323 transmits a request for key information to the distributed ledger 200, and the reception unit 324 receives the key information P2 transmitted from the distributed ledger 200 (S326). The verification unit 325 verifies the public key P2 read from the storage 321 with the key information P2 received from the distributed ledger 200 (S327). When it is determined that public key P2 has not been falsified (S328: YES), the data is encrypted using public key P2 and transmitted (S329). When it is determined that public key P2 has been falsified (S328: NO), the data is not encrypted and is not transmitted (S330). Also, when the digital certificate is not valid (S324: NO), the data is not encrypted and is not transmitted (S330). Furthermore, when it is not determined that it is the predetermined timing (S325: NO), the data is encrypted using the public key P2 and transmitted (S329).

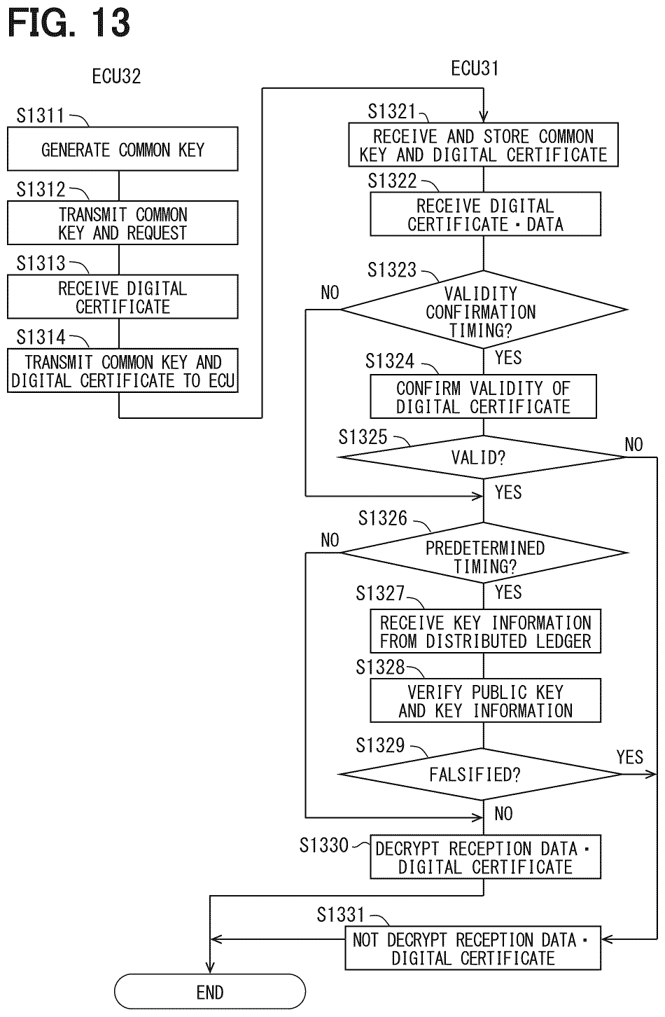

The operation of verifying the public key P2 and decrypting the digital signature in the ECU 31 of the modification of the present embodiment will be described with reference to the flowchart of FIG. 13.

First, the operation of the ECU 32 will be described. The controller 322 of the ECU 32 generates the public key P1 using the secret key S1 (S1311). The transmission unit 323 transmits the generated public key P1 and a request for issuance of a digital certificate to the certificate authority 300 (S1312). The reception unit 324 receives the digital certificate issued by the certificate authority 300 (S1313). Then, the transmission unit 323 transmits the public key P1 and the digital certificate to the ECU 31 (S1314).

Next, the operation of the ECU 31 will be described. The reception unit 314 of the ECU 31 receives the public key P1 and the digital certificate, and stores them in the storage 311 as the public key P2 and the digital certificate (S1321). Thereafter, at any timing, the reception unit 314 of the ECU 31 receives the encrypted data (S1322). For example, the ECU 32 receives the digital signature and data generated by the ECU 32 using the secret key S1 at the reception unit 314 of the ECU 31. The validity confirmation unit 316 determines whether it is time to confirm the validity of the digital certificate (S1323). When it is time to confirm the validity of the digital certificate (S1323: YES), the validity confirmation unit 316 transmits a confirmation signal to the certificate authority 300 for inquiring about the validity of the digital certificate, and receives the authentication result from the certificate authority 300 (S1324). When it is not time to confirm the validity (S1323: NO), the process proceeds to a process of determining whether it is a predetermined timing (S1326). When the digital certificate is valid (S1325: YES), the verification unit 315 determines whether it is the predetermined timing (S1326). When it is determined that it is the predetermined timing (S1326: YES), the transmission unit 313 transmits a request for key information to the distributed ledger 200, and the reception unit 314 receives the key information P2 transmitted from the distributed ledger 200 (S1327). The verification unit 315 verifies the public key P2 read from the storage 311 with the key information P2 received from the distributed ledger 200 (S1328). When it is determined that public key P2 has not been falsified (S1329: YES), the data and the digital signature are decrypted using the public key P2 (S1330). When it is determined that public key P2 has been falsified (S1329: NO), the data and the digital signature are not decrypted (S1331). Also, when the digital certificate is not valid (S1325: NO), the data and the digital signature are not decrypted (S1331). Furthermore, when it is not determined that the predetermined timing has arrived (S1326: NO), the data and the digital signature are decrypted using the public key P2 (S1330).

### (4) Other

In both the present embodiment and the modification of the present embodiment, the description focuses on two ECUs in the electronic control system 100, one transmitting data and the other receiving data. However, the same applies to the other ECUs included in the electronic control system 100. In this case, the distributed ledger and certificate authority used by the other ECUs may be separate from the distributed ledger 200 and certificate authority 300. In other words, when the electronic control system 100 contains a mixture of ECUs manufactured by multiple manufacturers or ECUs provided for individual services, it may be possible to use, for example, the distributed ledger or certificate authority managed by each ECU manufacturer or service provider.

### (5) Short Overview

In addition to the effects of the first and second embodiments, the present embodiment has the validity confirmation unit. Therefore, it is possible to further ensure the security of the public key P2 by the digital certificate issued by the certificate authority. In addition, the frequency of the validity confirmation by the validity check unit is set lower than the frequency of the predetermined timing for the confirmation. Therefore, it is possible to increase the security of the public key P2 while appropriately preventing the traffic on the communication line.

### 5. Fourth Embodiment

In the first to third embodiments, it is assumed that the distributed ledger 200 is provided outside the vehicle. In the present embodiment, the distributed ledger 200 is provided inside the vehicle, i.e., in other ECUs included in the electronic control system 100 mounted on the vehicle.

The overview of the present embodiment will be described with reference to FIGS. 14A, 14B, and 14C. FIG. 14A shows the destination of the verification and validation confirmation in the third embodiment. In the third embodiment, the verification destination for the verification unit 325 of the ECU 32 is the distributed ledger 200, and the confirmation destination for the validity confirmation unit 326 is the certificate authority 300. FIGS. 14B and 14C show the destination of the verification and validation confirmation in the present embodiment. In the present embodiment, the confirmation destination for a verification unit 425 of an ECU 42 is the distributed ledger set in a storage 411 of the integrated ECU, and the confirmation destination for a validity confirmation unit 426 is the certificate authority 300. Furthermore, in FIG. 14C, the verification destination for a verification unit 415 of the integrated ECU is the distributed ledger 200. Hereinafter, the case of FIG. 14C will be described.

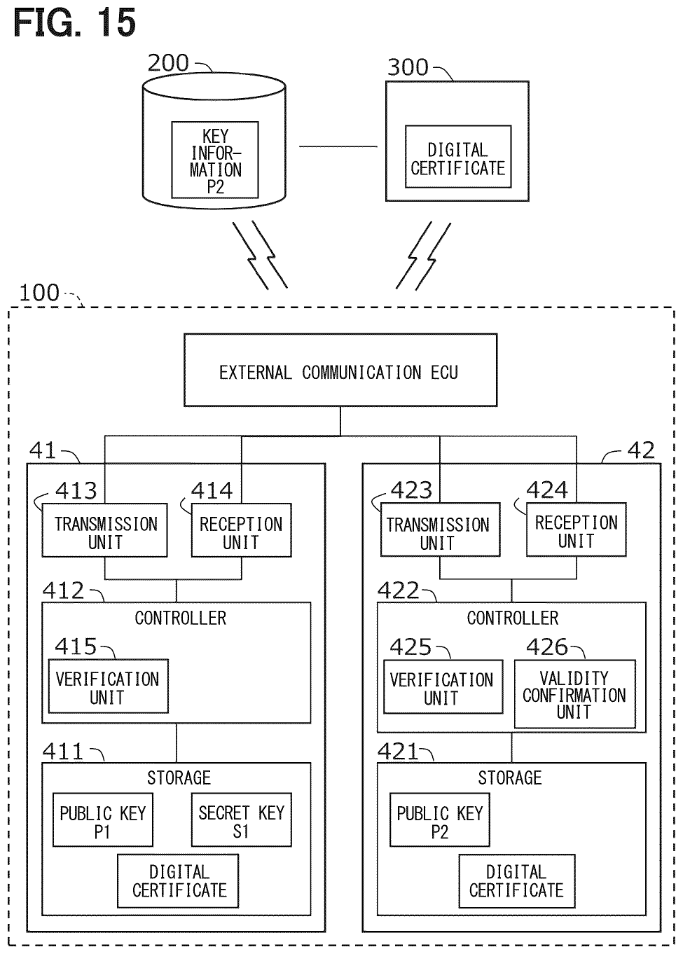

The configurations of the ECU 42 and the integrated ECU in the present embodiment will be described with reference to FIG. 15.

An ECU 41 and the ECU 42 may be any combination of the ECUs shown in FIG. 2, but in the present embodiment, the ECU 41 is an integrated ECU, and the ECU 42 is an individual ECU. The ECU 41 (integrated ECU, corresponding to the “second electronic control unit”) has the storage 411, a controller 412, a transmission unit 413, and a reception unit 414. The controller 412 also includes the verification unit 415. The ECU 42 (corresponding to the “first electronic control unit”) has a storage 421, a controller 422, a transmission unit 423, and a reception unit 424. The controller 422 also includes the verification unit 425 and the validity confirmation unit 426. Only the differences from the third embodiment will be described below, and the same parts as the third embodiment will be described citing the description of the first embodiment.

In the present embodiment, the function of the distributed ledger from the perspective of the ECU 42 is performed by the storage 411 of the ECU 41 (integrated ECU). That is, the public key P1 generated from the secret key S1 is stored in a distributed ledger (corresponding to the “first distributed ledger”) set in the storage 411.

Then, the verification unit 425 of ECU 42 (corresponding to a “first verification unit”) compares, at a predetermined timing (corresponding to a “first predetermined timing”), the public key P2 stored in its own storage 421 with the public key P1 stored in the distributed ledger set in the storage 411 of ECU 41 (integrated ECU) rather than the distributed ledger 200. In this example, what is stored in the distributed ledger set in the storage 411 is the public key P1 itself, but the key information P1 of the public key P1 may be stored. It should be noted that it is not necessary to set up the distributed ledger in the storage 411, and it is sufficient for the storage 411 to store the public key P1 or the key information P1.

In addition, the verification unit 415 (corresponding to the “second verification unit”) of ECU 41 (integrated ECU) verifies the public key P1 stored in the storage 411 with the key information P2 stored in the distributed ledger 200 (corresponding to the “second distributed ledger”) at a predetermined timing (corresponding to the “second predetermined timing”). The configuration and operation of the ECU 41 (integrated ECU) are the same as those in the second and third embodiments.

When comparing the frequency of the predetermined timing in the verification of the ECU 41 (integrated ECU) with the frequency of the predetermined timing in the verification of the ECU 42, it is desirable that the former be lower than the latter. Since it is relatively rare for the keys of multiple ECUs included in the electronic control system 100 to be falsified simultaneously, it is usually possible to confirm whether the falsifying has occurred by comparing them with the public key P1 of the integrated ECU. At the same time, in case of falsifying, it is also possible to access the distributed ledger 200 outside the vehicle to confirm whether it has been falsified. Thereby, it is possible to reduce the frequency of communication with the outside without reducing the frequency of verification of the public key P1. It is possible to efficiently use the communication line resources.

Although the present embodiment has a configuration corresponding to FIG. 10 of the third embodiment, it may have a configuration corresponding to FIG. 11 of the third embodiment.

### 6. Other Embodiments

The examples of the first to fourth embodiments may be applied to only a part of the electronic control system 100 in the vehicle, as well as to the entire electronic control system 100. For example, it may be applied only between ECUs that control cameras, radars, and LiDARs, or between ECUs integrated with these.

### 7. Overview

The features of the electronic control unit, the distributed ledger, the certificate authority, and the like in each embodiment of the present disclosure have been described above.

Since terms used in the embodiments are examples, the terms may be replaced with synonymous terms or terms including synonymous functions.

The block diagrams used for the description of the embodiments are obtained by classifying and organizing the configurations of the devices for each function. The blocks representing the respective functions may be implemented by any combination of hardware or software. Since the blocks represent the functions, such a block diagram may also be understood as disclosures of a method and a program for implementing the method.

An order of functional blocks that can be understood as processes, flows, and methods described in the embodiments may be changed as long as there are no restrictions such as a relation in which results of preceding processes are used in one other process.

The terms such as first, second, to N-th (where N is an integer) used in each embodiment and in the claims are used to distinguish two or more configurations and methods of the same kind and are not intended to limit the order or superiority.

In each embodiment, the electronic control unit disclosed in each embodiment is mounted on a vehicle. However, the electronic control unit may be carried by a pedestrian.

In addition, examples of the form of the electronic control unit, distributed ledger, and certificate authority of the present disclosure are as follows. Examples of component include a semiconductor element, an electronic circuit, a module, and a microcomputer. Examples of a form of a semi-finished product include an electronic control unit (ECU) and a system board. Example of the security management device according to the present disclosure include a mobile phone, a smartphone, a tablet, a personal computer (PC), a workstation, a server, and a cloud server. Other examples of the present disclosure may include a device having communication function, such as a video camera, a still camera, or a car navigation system.

In addition, necessary functions such as an antenna and a communication interface may be added to the electronic control unit, the distributed ledger, and the certificate authority.

It is supposed that the distributed ledger and the certificate authority of the present disclosure may be used to provide various services. In conjunction with providing such services, the distributed ledger and certificate authority of the present disclosure may be used, the method of the present disclosure may be used, or/and the program of the present disclosure may be executed.

The present disclosure is implemented not only by dedicated hardware having a configuration and a function described in relation to each embodiment. The present disclosure can also be implemented as a combination of a program for implementing the present disclosure, recorded on such a recording medium as memory and a hard disk and general-purpose hardware including dedicated or general-purpose CPU, memory, or the like, capable of executing the program.

A program stored in a non-transitory tangible storage medium (for example, an external storage device (a hard disk, a USB memory, and a CD/BD) of dedicated or general-purpose hardware, or an internal storage device (a RAM, a ROM, and the like)) may also be provided to dedicated or general-purpose hardware via the storage medium or from a server via a communication line without using the storage medium. Thereby, the latest functions can be provided at all times through program upgrade.

### INDUSTRIAL APPLICABILITY

The electronic control unit according to the present disclosure has been described mainly as an vehicle use purpose electronic control unit mounted on vehicle. The log management device may also be applied to general moving bodies such as pedestrians, motorcycles, bicycles with electric motors, railways, ships, and aircrafts.

What is claimed is:

1. An electronic control unit mounted on a vehicle, the electronic control unit comprising:
a storage that stores a key; and
a verification unit configured to verify, for each predetermined time, the key stored in the storage with key information that is information related to the key and is stored in a distributed ledger placed outside the vehicle.

2. The electronic control unit according to claim 1, further comprising:
a reception unit configured to receive a digital certificate of the key; and
a validity confirmation unit configured to confirm a validity of the digital certificate via a certificate authority.

3. The electronic control unit according to claim 2, wherein
a frequency of validity confirmation by the validity confirmation unit is lower than a frequency of a predetermined time.

4. The electronic control unit according to claim 1, wherein
the storage stores a verification result by the verification unit, and
the electronic control unit determines whether to use the key based on the verification result when using the key.

5. The electronic control unit according to claim 1, wherein
in addition to a second distributed ledger that is the distributed ledger, a first distributed ledger is provided in the vehicle.

6. The electronic control unit according to claim 1, wherein
the predetermined time is each first predetermined time when the vehicle is possible to communicate with an outside of the vehicle while the vehicle is traveling.

7. The electronic control unit according to claim 6, wherein
the first predetermined time is determined according to a speed of the vehicle.

8. The electronic control unit according to claim 1, wherein
the predetermined time is within a third predetermined time after the vehicle resumes communication with the outside when the vehicle has not communicated with the outside for a second predetermined time or more.

9. The electronic control unit according to claim 1, wherein
the predetermined time is each fourth predetermined time when the vehicle is possible to communicate with an outside of the vehicle while the vehicle is parked.

10. A key verification method executed in an electronic control unit mounted on a vehicle, the method comprising:
storing a key in a storage; and
verifying, for each predetermined time, the key stored in the storage with key information that is information related to the key and is stored in a distributed ledger placed outside the vehicle.

11. A non-transitory computer-readable storage medium storing a key verification program executable in an electronic control unit mounted on a vehicle, the program being configured to:
store a key in a storage; and
verify, for each predetermined time, the key stored in the storage with key information that is information related to the key and is stored in a distributed ledger placed outside the vehicle.

12. An electronic control system comprising:
a plurality of electronic control units mounted on a vehicle,
wherein
each of the plurality of electronic control units includes:
a storage that stores a key; and
a verification unit configured to verify, for each predetermined time, the key stored in the storage with key information that is information related to the key and is stored in a distributed ledger.

13. The electronic control system according to claim 12, wherein
when the plurality of electronic control units are a first electronic control unit and a second electronic control unit,
the predetermined time in the first electronic control unit is different from the predetermined time in the second electronic control unit.

14. A key management system comprising:
an electronic control unit mounted on a vehicle; and
a distributed ledger placed outside the vehicle,
wherein
the electronic control unit includes:
a storage that stores a key; and
a verification unit configured to verify, for each predetermined time, the key stored in the storage with key information that is information related to the key and is stored in a distributed ledger.

15. A key management system comprising;
an electronic control unit mounted on a vehicle;
a distributed ledger placed outside the vehicle; and
a certificate authority,
wherein
the electronic control unit includes:
a storage that stores a key;
a verification unit configured to verify, for each predetermined time, the key stored in the storage with key information that is information related to the key and is stored in a distributed ledger; and
a validity confirmation unit configured to confirm a validity of digital certificate related to the key via a certificate authority.

16. A key management system comprising:
an electronic control system including a first electronic control unit and a second electronic control unit mounted on a vehicle,
wherein
the first electronic control unit includes:
a first storage that stores a key; and
a first verification unit configured to verify, for each first predetermined time, the key stored in the first storage with first key information that is information related to the key and is stored in the second electronic control unit,
the second electronic control unit includes:
a second storage that stores the key; and
a second verification unit configured to verify, for each second predetermined time, the key stored in the second storage with second key information that is information related to the key and is stored in a distributed ledger placed outside the vehicle.

17. The key management system according to claim 16, wherein
a frequency of the second predetermined time is lower than a frequency of the first predetermined time.
